(19) United States
(12) Patent Application Publication
(10) Pub. No.: US 2026/0312132 A1
(43) Pub. Date: Oct. 8, 2026

(54) NON-AQUEOUS ELECTROLYTIC SOLUTION FOR LITHIUM ION SECONDARY BATTERY AND LITHIUM ION SECONDARY BATTERY USING SAME

(71) Applicant: Air Water Performance Chemical Inc., Kanagawa (JP)

(72) Inventors: Koji Abe, Ube-shi, Yamaguchi (JP); Yanko Marinov Todorov, Ube-shi, Yamaguchi (JP); Qing Zhang, Izumisano-City, Osaka (JP); Jiayu Li, Izumisano-City, Osaka (JP)

(73) Assignee: Air Water Performance Chemical Inc., Kanagawa (JP)

(21) Appl. No.: 18/878,225

(22) PCT Filed: Jun. 1, 2023
(86) PCT No.: PCT/JP2023/020565

§ 371 Date: Dec. 23, 2024

(30) Foreign Application Priority Data
Jul. 1, 2022 (JP) 2022-107065

(51) Int. Cl. H01M 10/0567; B60L 50/64; H01M 10/0525

(52) U.S. Cl. CPC H01M 10/0567; H01M 10/0525; B60L 50/64; H01M 2300/0037

(57) ABSTRACT

Provided are a non-aqueous electrolyte for providing a lithium ion secondary battery that is superior in cycling performances (cycle life) important for automotive secondary batteries for use in electric automobiles etc. and further in corrosion resistance at high voltages in excess of 4.2 V or at high temperatures, and such a lithium ion secondary battery. The non-aqueous electrolyte is for use in a lithium ion secondary battery including a positive electrode, a negative electrode, a separator, and a non-aqueous electrolyte containing a non-aqueous solvent and an electrolyte salt dissolved in the non-aqueous solvent, and characterized by containing a five-membered cyclic phosphonic acid ester compound (I) in an amount ranging from 0.01 wt % to 10 wt %. In the formula, R represents a —CH₂C≡CH group, a —CH(CH₃)C≡N group, a —C(CH₃)₂C≡N group, or a —CH₂CH₂C≡N group.

### CROSS REFERENCE TO RELATED APPLICATIONS

This application is a US national stage filing under 35 U.S.C. § 371 of International Application No. PCT/JP2023/020565 filed Jun. 1, 2023, which claims priority to Japanese Patent Application No. 2022-107065 filed Jul. 1, 2022, each of which is incorporated herein by reference in its entirety.

### TECHNICAL FIELD

This disclosure relates to a non-aqueous electrolyte for providing a lithium ion secondary battery that is superior in battery characteristics such as a cycle life as well as in safety such as corrosion resistance, and also to a lithium ion secondary battery using the non-aqueous electrolyte.

### BACKGROUND

In recent years, lithium ion secondary batteries (LIBs) have become increasingly larger in capacity and higher in voltage, and attempts are being made to improve their cycle life, high-temperature storage characteristics, and the like. LIBs in which a Ni-containing lithium complex oxide is used as a positive electrode active material, a graphite material or a Si-containing compound is used as a negative electrode active material, and a non-aqueous electrolyte containing lithium bis(fluorosulfonyl)imide (LiFSI) is used as an electrolyte salt have been put to practical use as automotive secondary batteries.

Positive electrode materials used in currently available LIBs for electric automobiles are being improved to increase the nickel content therein, and negative electrodes used in the same are being improved to add a silicon-based material to conventionally used graphite materials and further to increase the blending ratio of the silicon-based material. These improvements are intended to increase the energy density of a battery as a whole, thereby extending the driving range of electric automobiles.

LIBs for electric automobiles today are required to exhibit high performance in a wide variety of environments. In particular, performance at high temperatures is important. When a cell in an automotive LIB is exposed to a high temperature due to the influence of heat from the inside and outside the LIB, gas generation caused by the decomposition of the electrolyte is accelerated, and at the same time, metal ions are dissolved from the positive electrode and deposited on the negative electrode, whereby the battery performance is deteriorated.

On the other hand, in the negative electrode, if a protective coating layer is deteriorated by heat, the negative electrode surface, which is highly active, comes into direct contact with the solvent and thus self-discharges, whereby the battery performance is deteriorated. There is a concern that this may bring about more pronounced adverse effects on positive electrodes with a high Ni content and negative electrodes formed of a Si-based material, because they are both inferior in terms of structural stability and high-temperature performance.

JP 2014-203748 A has pointed out a problem in that a non-aqueous electrolyte containing an imide lithium salt such as LiFSI corrodes aluminum used as a positive electrode current collector of an LIB when the LIB is operated at high voltages in excess of 4.2 V.

JP 2015-99660 A has proposed using a non-aqueous electrolyte containing: a cyclic phosphoric acid ester compound (A) such as ethylene(2-propynyl)phosphate; a lithium salt compound (B) that does not have an oxalic acid structure, such as LiPF6; a lithium salt compound (C) that has an oxalic acid structure, such as LiB(C₂O₄)₂ (LiBOB); and a non-aqueous electrolyte containing a non-aqueous solvent, thereby achieving a LIB that has excellent capacity retention and is less likely to generate gas after continuous charging.

However, battery characteristics, such as a cycle life and corrosion resistance when used at high voltages or high temperatures, attained by these techniques are still not at satisfactory levels.

It could therefore be helpful to provide a non-aqueous electrolyte for providing a lithium ion secondary battery that is superior in cycling performances (cycle life) important for automotive secondary batteries for use in electric automobiles etc. and further in corrosion resistance at high voltages in excess of 4.2 V or at high temperatures, and also to provide such a lithium ion secondary battery.

### SUMMARY

We have conducted intensive studies, and as a result, devised a non-aqueous electrolyte for use in a lithium ion secondary battery that includes a positive electrode, a negative electrode, a separator, and a non-aqueous electrolyte containing a non-aqueous solvent and an electrolyte salt dissolved in the non-aqueous solvent, wherein the non-aqueous electrolyte contains a five-membered cyclic phosphonic acid ester compound represented by the following formula (I) in an amount ranging from 0.01 wt % to 10 wt %. We have found out that a non-aqueous electrolyte with the above-described composition is capable of providing a lithium ion secondary battery that exhibits improved cycling performances and high corrosion resistance at high voltages in excess of 4.2 V or at high temperatures.

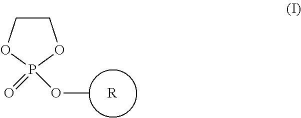

In the formula, R represents a —CH₂C≡CH group, a —CH(CH₃)C≡N group, a —C(CH₃)₂C≡N group, or a —CH₂CH₂C≡N group.

When R in the five-membered cyclic phosphonic acid ester compound represented by the formula (I) is the —CH₂C≡CH group, it is preferable that the electrolyte salt does not contain LiPF₆ or LiBOB.

It is preferable that the non-aqueous electrolyte containing the five-membered cyclic phosphonic acid ester compound represented by the formula (I) further contains 1,3-dioxane (DOX, CAS RN: 505-22-6) in an amount ranging from 0.01 wt % to 5 wt %. By further adding DOX to the non-aqueous electrolyte, the cycling performances and the corrosion resistance at high voltages in excess of 4.2 V or at high temperatures can be further improved. This effect is particularly remarkable when lithium bis(fluorosulfonyl)imide (LiFSI) is used as the electrolyte salt.

The non-aqueous electrolyte may contain at least one SO₃ group-containing compound selected from the group consisting of 1,3-propanesultone, propargyl methanesulfonate, and 2-cyanoethyl methanesulfonate in an amount ranging from 0.01 wt % to 5 wt %.

Our solution also provides a lithium ion secondary battery including a positive electrode, a negative electrode, a separator, and a non-aqueous electrolyte containing a non-aqueous solvent and an electrolyte salt dissolved in the non-aqueous solvent, wherein the non-aqueous electrolyte is the non-aqueous electrolyte for use in a lithium ion secondary battery.

In the lithium ion secondary battery, it is preferable that the negative electrode contains a silicon-based oxide.

Our solution can provide a non-aqueous electrolyte for providing a lithium ion secondary battery that is superior in cycling performances (cycle life) important for automotive secondary batteries for use in electric automobiles etc. and further in corrosion resistance at high voltages in excess of 4.2 V or at high temperatures, and also can provide such a lithium ion secondary battery.

### DETAILED DESCRIPTION

In the following, illustrative examples and configurations will be described. It is to be noted, however, that this disclosure is not limited thereto and may encompass any example and configuration that does not depart from the scope and spirit of the descriptions contained herein.

The non-aqueous electrolyte is composed of an electrolyte salt and a non-aqueous solvent. Examples of the electrolyte salt include lithium salts such as LiN(SO₂F)₂ having an SO₂ group (LiFSI), LiOSO₂F having an SO₃ group, LiOSO₃CH₃ having an SO₄ group, LiOSO₃C₂H₅, LiPF₆ having phosphorus (P), and LiPO₂F₂. It is to be noted, however, when a graphite material such as natural graphite or artificial graphite contains a silicon-based oxide such as SiO or SiO₂, the electrolyte salts excluding LiBOB having an oxalic acid skeleton and LiPF₆ are preferably used. One of the above-described lithium salts may be used alone, or two or more of them may be used. The Li salts other than LiFSI exhibit an auxiliary effect of improving the battery performance at low temperatures. Accordingly, it is preferable to add a certain amount of such an Li salt(s). Preferable combinations of these lithium salts include: the combination of two types of lithium salts, a lithium salt with an SO₂ group and phosphorus (P); and the combination of three types of lithium salts, a lithium salt having an SO₃ group, a lithium salt having an SO₄ group, and a lithium salt having phosphorus (P). Specifically, the combination of two types of lithium salts, LiFSI and LiPO₂F₂, and the combination of three types of lithium salts, LiFSI, LiOSO₃CH₃, and LiPO₂F₂, are more preferable. The molar ratio of LiFSI/Li salt(s) other than LiFSI is preferably in the range from 100/0 to 1/99, more preferably 100/0 to 60/40, and most preferably 100/0 to 80/20. The electrolyte salt(s) is preferably dissolved such that the total concentration (mol/L) thereof is in the range from 0.5 to 3 and more preferably from 1 to 2.

As the solvent of the electrolyte, a five-membered cyclic carbonate or a chain carbonate can be used as a main solvent. Preferable examples of the five-membered cyclic carbonate include ethylene carbonate (EC), fluoroethylene carbonate (FEC), propylene carbonate (PC), and vinylene carbonate (VC). When a chain carbonate is used, preferable examples thereof include dimethyl carbonate (DMC), ethyl methyl carbonate (EMC), and diethyl carbonate (DEC).

One of these solvents may be used, or two or more of them may be used in combination. When the lithium ion secondary battery includes a positive electrode active material containing Ni and/or a negative electrode active material containing Si, preferable combinations of the five-membered cyclic carbonates are the combinations in which FEC, which contains fluorine, is included, such as the combination of EC and FEC and the combination of EC, PC, and FEC, from the viewpoint of inhibiting corrosion, and preferable combinations of chain carbonates include the combinations in which an asymmetric chain carbonate is included, such as the combination of DMC and EMC and the combination of DEC and EMC, from the viewpoint of improving the electrochemical properties in a high temperature region of 45° C. or above and a low temperature region of −20° C. or below.

When a five-membered cyclic carbonate is used as the non-aqueous solvent of the non-aqueous electrolyte and a chain ester (chain carbonate) is further contained in addition to the five-membered cyclic carbonate, the ratio between the five-membered cyclic carbonate and the chain carbonate (five-membered cyclic carbonate:chain carbonate) is preferably 10:90 to 50:50 (volume ratio) and more preferably 20:80 to 40:60 from the viewpoint of improving the electrochemical properties in a high temperature region of 45° C. or above and a low temperature region of −20° C. or below.

The non-aqueous electrolyte contains a five-membered cyclic phosphonic acid ester compound represented by the following formula (I) in an amount ranging from 0.01 wt % to 10 wt %. In the formula, R represents a —CH₂C≡CH group, a —CH(CH₃)C≡N group, a —C(CH₃)₂C≡N group, or a —CH₂CH₂C≡N group. By adding the five-membered cyclic phosphonic acid ester compound, the corrosion resistance against aluminum and other metals is improved. This also allows the use of a larger amount of LiFSI (lithium bis(fluorosulfonyl)imide), which is highly chemically and thermally stable and capable of improving the battery performance at high temperatures. The five-membered cyclic phosphonic acid ester compound may be any of a compound represented by the formula (I) where R is a —CH₂C≡CH group, a compound represented by the formula (I) where R is a —CH(CH₃)C≡N group, a compound represented by the formula (I) where R is a —C(CH₃)₂C≡N group, or a compound represented by the formula (I) where R is a —CH₂CH₂C≡N group, or may be a mixture of any two or more of these compounds.

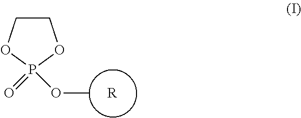

If the added amount of the five-membered cyclic phosphonic acid ester compound (I) is too small, a protective coating cannot be sufficiently formed on the negative electrode. This deteriorates the cycling performances, and also affects the high-temperature storage characteristics. Accordingly, a suitable amount of the five-membered cyclic phosphonic acid ester compound (I) to used is preferably at least 0.1 wt % and more preferably at least 0.5 wt % with respect to the non-aqueous solvent. The upper limit is preferably 5 wt % or less and more preferably 3 wt % or less with respect to the non-aqueous solvent.

To further enhance the effect of improving the cycling performances and the corrosion resistance by the five-membered cyclic phosphonic acid ester compound (I), the electrolyte may further contain 1,3-dioxane (DOX), which is a six-membered cyclic ether, in an amount ranging from 0.01 wt % to 5 wt %. The non-aqueous electrolyte containing this compound in the range form 0.01 wt % to 0.5 wt % allows the battery to have still higher levels of cycling performances and corrosion resistance at high voltages in excess of 4.2 V and/or at temperatures above room temperature.

The reason why the use of DOX in combination is preferable will be described in the following, which, however, remains merely speculative: when the five-membered cyclic phosphonic acid ester compound (I) in which R is a —CH₂C≡CH group, a —CH(CH₃)C≡N group, a —C(CH₃)₂C≡N group, or a —CH₂CH₂C≡N group undergoes ring-opening polymerization, a six-membered cyclic ether DOX also undergoes ring-opening polymerization, whereby a polymer adsorption layer exhibiting a strong synergistic effect is formed at the interface with the positive electrode active material and the interface with the negative electrode active material to prevent contact between these active materials and the main solvent of the electrolyte. The amount of DOX to be used is preferably at least 0.01 wt %, more preferably at least 0.1 wt %, and most preferably at least 0.5 wt % with respect to the non-aqueous solvent. The upper limit is preferably 5 wt % or less, more preferably 4 wt % or less, and most preferably 3 wt % or less with respect to the non-aqueous solvent.

It becomes possible to use a non-aqueous electrolyte containing 1,3-propanesultone (CAS RN: 1120-71-4), propargyl methanesulfonate (CAS RN: 16156-58-4), or 2-cyanoethyl methanesulfonate (CAS RN: 65885-27-0) in an amount ranging from 0.01 wt % to 5 wt % without deteriorating the corrosion resistance of LIBs, whereas they are SO₃ group-containing compounds that are preferable to use from the viewpoint of improving the cycle life but have generally been avoided to use because of their high corrosiveness.

The separator used in the lithium ion secondary battery is most preferably a microporous membrane (porous sheet) formed of a polyolefin material such as polypropylene or polyethylene, and a separator made of nonwoven fabric also can be used. The porous sheet or nonwoven fabric may have a single layer structure or a multilayer structure, and the surface of the separator may be coated with an oxide such as alumina. The thickness of the separator needs to be made as small as possible to increase the volumetric energy density of the battery. Accordingly, the thickness of the separator is preferably 20 microns or less and particularly preferably 10 microns or less.

As the negative electrode active material used in the lithium ion secondary battery, graphite materials such as natural graphite and artificial graphite, which can reversibly inserting and extracting lithium ions, are preferable to increase the volumetric energy density. Further, to increase the capacity, it is preferable to add a silicon-based oxide such as SiO or SiO₂ thereto. When the negative electrode active material contains graphite and at least one type of silicon-based oxide, the proportion of the silicon-based oxide in the negative electrode active material is preferably 1% to 30% by weight and more preferably 5% to 20% by weight.

As a negative electrode mixture, a negative electrode mixture in the form of slurry was prepared by adding, to the above-described negative electrode active material, a binder such as ethylene propylene diene terpolymer (EPDM), polytetrafluoroethylene (PTFE), polyvinylidene fluoride (PVDF), a styrene-butadiene copolymer (SBR), an acrylonitrile-butadiene copolymer (NBR), or carboxymethyl cellulose (CMC), and kneading the resulting mixture. Thereafter, this negative electrode mixture is applied onto a copper foil or aluminum foil as a current collector to produce a negative electrode. Then, the negative electrode is subjected to drying, pressure molding, and then heat treatment that is performed, for example, at 80° C. under vacuum.

Examples of the positive electrode active material used in the lithium ion secondary battery include LiCoO₂ (LCO), LiCo_{1/3}Ni_{1/3}Mn_{1/3}O₂ (NCM111), LiNi_{0.5}Co_{0.2}Mn_{0.3}O₂ (NCM523), LiNi_{0.6}Co_{0.2}Mn_{0.2}O₂ (NCM622), and LiNi_{0.8}Co_{0.1}Mn_{0.1}O₂ (NCM811). To increase the volumetric energy density, it is preferable to use NCM811, which is a positive electrode active material containing a lithium complex oxide in which the atomic ratio of Ni is 50% or more. Further, to improve rapid charge-discharge performance, it is preferable to use LiMn₂O₄ (LMO) having a spinel structure or LiFePO₄ (LFP) having an olivine structure.

A positive electrode mixture can be prepared using, as the above-described positive electrode active material, a known or commercially available conductive additive such as carbon black (e.g., acetylene black or Ketjen black), carbon nanotubes, carbon fibers, activated carbon, or graphite. By adding a binder such as polytetrafluoroethylene (PTFE), polyvinylidene fluoride (PVDF), a styrene-butadiene copolymer (SBR), an acrylonitrile-butadiene copolymer (NBR), or carboxymethyl cellulose (CMC) to the positive electrode active material and kneading the resulting mixture, a positive electrode mixture in the form of slurry is obtained. Thereafter, this positive electrode mixture is applied onto an aluminum foil as a current collector to produce a positive electrode. Then, the positive electrode is subjected to drying, pressure molding, and then heat treatment that is performed, for example, at 80° C. under vacuum.

In the lithium ion secondary battery, preferable examples of the combination of the positive electrode active material and the negative electrode active material include the combination of LCO and graphite, the combination of NCM523 and graphite, and the combination of NCM811 and graphite, to increase the volumetric energy density.

Current collectors to be used are not limited to particular types of current collectors, and an aluminum foil and a copper foil are preferable. Also, porous current collectors may be used to further improve the wettability to the electrolyte.

A solvent to be used for a binder is not limited to particular types of solvents, and various solvents can be selected according to an active material or binder to be used. Specifically, when PVDF is used as a binder, it is preferable to use N-methyl-2-pyrrolidone as the solvent, and when a rubber binder such as styrene-butadiene rubber (SBR), polytetrafluoroethylene, polyvinyl alcohol, or carboxymethyl cellulose (CMC) is used, preferable examples of the solvent include water.

The structure of the lithium ion secondary battery is not limited to particularly structures, and the secondary battery, which includes a positive electrode(s), a negative electrode(s), and a separator(s), may have a shape such as, for example, a coin shape, a cylindrical shape, a rectangular shape, or a pouch shape. In particular, it is preferable that the secondary battery is in a pouch shape because it allows excellent heat dissipation.

### EXAMPLES

In the following, our solution will be described more specifically with reference to examples and comparative examples. It is to be noted, however, that these examples and comparative examples do not limit this disclosure by any means.

### Example 1-1

### Preparation of Electrolyte

A non-aqueous electrolyte was prepared by adding a phosphonic acid ester compound (I) in which R═CH₂CH₂C≡N at a concentration of 1 wt % with respect to 100 vol % of an electrolyte (1 M LiFSI PC/DMC=1/2 (volume ratio)).

### Production of Lithium Ion Secondary Battery and Measurement of Battery Characteristics

93 wt % of NCM811 (positive electrode active material), 3 wt % of acetylene black (conductive additive), and 4 wt % of polyvinylidene fluoride (binder) were mixed together, and 1-methyl-2-pyrrolidone was added to the resulting mixture to turn the mixture into a slurry, and the slurry was applied onto an aluminum foil to produce a positive electrode. Thereafter, the positive electrode was dried and pressure-molded. Similarly, 98 wt % of artificial graphite (negative electrode active material) and 1 mass % of styrene-butadiene copolymer and 1 mass % of carboxymethyl cellulose, which are both binders, were mixed with water to obtain a slurry, and the slurry was applied onto a copper foil to produce a negative electrode sheet. Thereafter, the negative electrode sheet was dried, pressure-molded, and heat-treated. As a separator, a 20 micron-thick microporous film having a three-layer structure with a polyethylene film being sandwiched between polypropylene films was used. A coin battery (20 mm in diameter and 3.2 mm in thickness) was produced by injecting the above-described electrolyte. The results are shown in “Example 1-1” in Table 1.

Using a charging/discharging device ACD-MO1A (Asuka Electronics Co., Ltd.), this coin battery was subjected to repeated charge-discharge cycles using a constant current and a constant voltage at 25° C., with each charge-discharge cycle consisting of charging up to an upper limit voltage of 4.3 V at 1 C rate and then discharging to a lower limit voltage of 3.0 V at a 1 C rate. The discharge capacity at the 5th cycle was calculated as a relative ratio with respect to the discharge capacity at the 5th cycle of a battery using EC/DMC=1/2 (volume ratio) as a solvent (Comparative Example 1-2), and found to be 1.00. The cycling performances (%) were represented by the numerical value calculated as per the following formula: the capacity (mAh/g) obtained at the 50th cycle/the capacity (mAh/g) obtained at the 5th cycle×100. The results are shown in “Example 1-1” in Table 1.

TABLE 1

| | | | | Compound (I) | | | Relative | |
|---|---|---|---|---|---|---|---|---|
| | | | Composition of | Added | | | capacity | Cycling |
| | Positive | Negative | electrolyte (volume | amount | | DOX | at 5th | performances |
| | electrode | electrode | ratio) | (wt %) | Structure of R | (wt %) | cycle | (%) |
| Ex. 1-1 | NCM811 | Graphite | 1M LiFSI [PC/DMC = | 1 | R: —CH₂CH₂CN | 0 | 1.00 | 100 |
| | | | 1/2] | | | | | |
| Ex. 1-2 | NCM811 | Graphite | 1M LiFSI [PC/DMC = | 1 | R: —CH₂C≡CH | 0 | 0.88 | 99 |
| | | | 1/2] | | | | | |
| Ex. 1-3 | NCM811 | Graphite | 1M LiFSI [PC/DMC = | 1 | R: —CH₂C≡CH | 1 | 1.00 | 100 |
| | | | 1/2] | | | | | |
| Comp. | NCM811 | Graphite | 1M LiFSI [PC/DMC = | 0 | — | 0 | 0 | — |
| Ex. 1-1 | | | 1/2] | | | | | |
| Comp. | NCM811 | Graphite | 1M LiFSI [EC/DMC = | 0 | — | 0 | 1.00 | 98 |
| Ex. 1-2 | | | 1/2] | | | | | |
| Comp. | NCM811 | Graphite | 1M LiFSI [PC/DMC = | 0 | — | 1 | 0 | — |
| Ex. 1-3 | | | 1/2] | | | | | |
| Comp. | NCM811 | Graphite | 1M LiFSI [PC/DMC = | 1 | R: —CH₂CH₃ | 0 | 0 | — |
| Ex. 1-4 | | | 1/2] | | | | | |
| Comp. | NCM811 | Graphite | 1M LiFSI [PC/DMC = | 1 | R: —CH₂CF₃ | 0 | 0 | — |
| Ex. 1-5 | | | 1/2] | | | | | |

### Examples 1-2 to 1-3 and Comparative Examples 1-1 to 1-5

Coin batteries were produced and the battery characteristics thereof were measured in the same manner as in Example 1-1, except that the composition of the electrolyte, the compound (I), and DOX used in the batteries were changed as shown in Table 1. The results are shown in Table 1.

As can be seen from the results shown in Table 1, when the non-aqueous electrolyte containing the phosphonic acid ester compound (I) was not used as the PC-based electrolyte in the batteries using a graphite negative electrode, such batteries could not perform satisfactory charging and discharging as secondary batteries owing to damage to the graphite negative electrode (Comparative Examples 1-1 and 1-3 to 1-5). It was also found that, by adding DOX as an auxiliary additive, a synergistic effect was produced (Example 1-3), whereby the non-aqueous electrolyte allowed the LIB to have an initial capacity equivalent to that of a LIB using an EC-based electrolyte (Comparative Example 1-2) and also to have a cycle life superior to that of the LIB using the EC-based electrolyte.

### Example 2-1

### Measurement of Corrosion Resistance

Measurement of corrosion resistance was performed using a three-electrode beaker cell (working electrode/counter electrode/reference electrode=Al/Li/Li) and a non-aqueous electrolyte prepared by adding, to 1.2 M LiFSI EC/EMC/DMC=3/3/4 (volume ratio), a phosphonic acid ester compound (I) in which R═CH₂CH₂C≡N in an amount of 2.8 wt %. Under the measurement conditions of 25° C., 5 mV/sec, and 4.5 to 3.0 V, the current value was determined in every cycle up to the 10th cycle by cyclic voltammetry (CV). Using the thus-determined current values, the numerical value was determined as per the following formula: the current value at the 10th cycle/the current value at the 2nd cycle×100. The results are shown in “Example 2-1” in Table 2.

TABLE 2

| | | Compound (I) | | | Corrosion |
|---|---|---|---|---|---|
| | Composition of electrolyte | Added | | DOX | resistance |
| | (volume ratio) | amount | Structure of R | (wt %) | (%) |
| Ex. 2-1 | 1.2M LiFSI EC/EMC/DMC = 3/3/4 | 2.8 | R: —CH₂CH₂CN | 0 | 17 |
| Ex. 2-2 | 1.2M LiFSI EC/EMC/DMC = 3/3/4 | 2.5 | R: —CH₂C≡CH | 0 | 24 |
| Ex. 2-3 | 1.2M LiFSI EC/EMC/DMC = 3/3/4 | 2.5 | R: —CH₂CH₂CN | 1.4 | 15 |
| Comp. Ex. 2-1 | 1.2M LiFSI EC/EMC/DMC = 3/3/4 | 0 | — | 0 | 260 |
| Comp. Ex. 2-2 | 1.2M LiFSI EC/EMC/DMC = 3/3/4 | 2.4 | R: —CH₂CH₃ | 0 | 197 |
| Comp. Ex. 2-3 | 1.2M LiFSI EC/EMC/DMC = 3/3/4 | 3.2 | R: —CH₂CF₃ | 0 | 393 |
| Comp. Ex. 2-4 | 1.2M LiFSI EC/EMC/DMC = 3/3/4 | 0 | — | 1.4 | 62 |

### Examples 2-2 to 2-3 and Comparative Examples 2-1 to 2-4

A three-electrode beaker cell was produced and the corrosion resistance was measured in the same manner as in Example 2-1, except that the compound used was changed as shown in Table 2. The added amount of the compound was set to be the same molar amount as that of the phosphonic acid ester compound (I) in which R═CH₂CH₂C≡N. The results are shown in Table 2.

As can be seen from the results shown in Table 2, by adding the phosphonic acid ester compound (I) to the electrolyte, the numerical values representing the corrosion resistance decreased greatly (Examples 2-1 and 2-2). It was also found that, when DOX was used in combination as an auxiliary additive, the values representing the corrosion resistance further decreased (Example 2-3).

On the other hand, it was found that, of the five-membered cyclic phosphonic acid ester compounds (I) with the same phosphonic acid skeletal structure, those having an R moiety that does not fall within the scope of this disclosure, namely, R═CH₂CH₃ (Comparative Example 2-2) or R═CH₂CF₃ having a fluorine group (Comparative Example 2-3), greatly deteriorated the corrosion resistance. These results demonstrate that not all the compounds having a five-membered cyclic phosphonic acid skeletal structure would be effective but specific skeletal structures that do not cause damage to graphite negative electrodes are important.

### Example 3-1

A coin battery was produced and the battery characteristics thereof were measured in the same manner as in Example 1-1, except that a negative electrode sheet obtained by using graphite containing SiO as a negative electrode active material was used and that the electrolyte, the five-membered cyclic phosphonic acid ester compound (I), DOX, and propargyl methanesulfonate as an SO3-containing compound used in the battery were changed as shown in Table 3. The negative electrode sheet was produced in the following manner. 93 wt % of artificial graphite (negative electrode active material), 5 wt % of SiO (negative electrode active material), and 1 mass % of styrene-butadiene copolymer and 1 mass % of carboxymethyl cellulose, which are both binders, were mixed with water to obtain a slurry, and the slurry was applied onto a copper foil to produce a negative electrode sheet. Thereafter, the negative electrode sheet was dried, pressure-molded, and heat-treated. Further, a three-electrode beaker cell was produced and the corrosion resistance was measured in the same manner as in Example 2-1. The results are shown in Table 3.

### Examples 3-2 to 3-4

Coin batteries were produced and the battery characteristics thereof were measured in the same manner as in Example 3-1, except that the five-membered cyclic phosphonic acid ester compound (I) was changed as shown in Table 3. Further, a three-electrode beaker cell was produced and the corrosion resistance was measured in the same manner as in Example 2-1. The results are shown in Table 3.

TABLE 3

| | | | | Compound (I) | | SO₃- | | | |
|---|---|---|---|---|---|---|---|---|---|
| | | | Composition of | Added | | containing | | | Corrosion |
| | Positive | Negative | electrolyte | amount | | compound | DOX | Cycling | resistance |
| | electrode | electrode | (volume ratio) | (wt %) | Structure of R | (wt %) | (wt %) | performances | (%) |
| Ex. | NCM811 | Graphite + | (1M LiFSI + | 1 | R: —CH₂CH₂CN | 1 | 1 | 100 | 15 |
| 3-1 | | SiO | 0.06M LiPO₂F₂ + | | | | | | |
| | | | 0.04M LiOSO₃CH₃) | | | | | | |
| | | | [EC/FEC/EMC/DMC = | | | | | | |
| | | | 2.5/0.5/3/4] | | | | | | |
| Ex. | NCM811 | Graphite + | (1M LiFSI + | 1 | R: —CH(CH₃)CN | 1 | 1 | 100 | 12 |
| 3-2 | | SiO | 0.06M LiPO₂F₂ + | | | | | | |
| | | | 0.04M LiOSO₃CH₃) | | | | | | |
| | | | [EC/FEC/EMC/DMC = | | | | | | |
| | | | 2.5/0.5/3/4] | | | | | | |
| Ex. | NCM811 | Graphite + | (1M LiFSI + | 1 | R: —C(CH₃)₂CN | 1 | 1 | 100 | 13 |
| 3-3 | | SiO | 0.06M LiPO₂F₂ + | | | | | | |
| | | | 0.04M LiOSO₃CH₃) | | | | | | |
| | | | [EC/FEC/EMC/DMC = | | | | | | |
| | | | 2.5/0.5/3/4] | | | | | | |
| Ex. | NCM811 | Graphite + | (1M LiFSI + | 0.3 | R: —CH₂CH₂CN | 1 | 1 | 100 | 10 |
| 3-4 | | SiO | 0.06M LiPO₂F₂ + | 0.7 | R: —CH(CH₃)CN | | | | |
| | | | 0.04M LiOSO₃CH₃) | | | | | | |
| | | | [EC/FEC/EMC/DMC = | | | | | | |
| | | | 2.5/0.5/3/4] | | | | | | |

As can be seen from Table 3, even with the use of non-aqueous electrolytes containing not only highly corrosive LiFSI but also LiOSO₃CH₃ as an SO₄-containing compound, propargyl methanesulfonate as an SO₃-containing compound, and FEC as a fluorine-containing compound, the corrosion resistance was improved. From these results, it is expected that our solution is effective in providing excellent cycling performances and corrosion resistance over a long period of time where many LIBs are used, such as the automotive batteries.

### Example 4-1 and Reference Examples 4-1 to 4-6

Coin batteries were produced in the same manner as in Example 1-1, except that the same positive electrode active material as used in Example 3-1, the same solvent as used in Example 2-1, and the same five-membered cyclic phosphonic acid ester compound (I) as used in Example 1-2 were used and that the type of the negative electrode used in the batteries, the ratio between LiPF₆ and LiFSI in the electrolyte, and the addition of LiBOB were changed as shown in Table 4. The battery characteristics of these coin batteries were measured in the following manner. Using a charging/discharging device ACD-MO1A (Asuka Electronics Co., Ltd.), these coin batteries were subjected to repeated charge-discharge cycles using a constant current and a constant voltage at 25° C., with each charge-discharge cycle consisting of charging up to an upper limit voltage of 4.3 V at 1 C rate and then discharging to a lower limit voltage of 3.0 V at a 1 C rate. The discharge capacity at the 5th cycle was calculated as a relative ratio with respect to the discharge capacity at the 5th cycle of the battery of Comparative Example 1-2. The cycling performances (%) were represented by the numerical value calculated as per the following formula: the capacity (mAh/g) obtained at the 300th cycle/the capacity (mAh/g) obtained at the 5th cycle×100. The results are shown in Table 4.

TABLE 4

| | | | | Compound (I) | | Relative | |
|---|---|---|---|---|---|---|---|
| | | | | Added | | capacity | Cycling |
| | Positive | Negative | Composition of electrolyte | amount | | at 5th | performances |
| | electrode | electrode | (volume ratio) | (wt %) | Structure of R | cycle | % |
| Ex. 4-1 | NCM811 | Graphite + SiO | 1M LiFSI | 1 | R: —CH₂C≡CH | 1.00 | 82 |
| | | | [EC/EMC/DMC = 3/3/4] | | | | |
| Ref. | NCM811 | Graphite + SiO | (0.75M LiFSI + 0.25M LiPF₆) | 1 | R: —CH₂C≡CH | 0.98 | 69 |
| Ex. 4-1 | | | [EC/EMC/DMC = 3/3/4] | | | | |
| Ref. | NCM811 | Graphite + SiO | (0.5M LiFSI + 0.5M LiPF₆) | 1 | R: —CH₂C≡CH | 0.96 | 64 |
| Ex. 4-2 | | | [EC/EMC/DMC = 3/3/4] | | | | |
| Ref. | NCM811 | Graphite + SiO | (0.25M LiFSI + 0.75M LiPF₆) | 1 | R: —CH₂C≡CH | 0.94 | 55 |
| Ex. 4-3 | | | [EC/EMC/DMC = 3/3/4] | | | | |
| Ref. | NCM811 | Graphite + SiO | (0.01M LiFSI + 0.99M LiPF₆) | 1 | R: —CH₂C≡CH | 0.93 | 49 |
| Ex. 4-4 | | | [EC/EMC/DMC = 3/3/4] | | | | |
| Ref. | NCM811 | Graphite | 1M LiPF₆ | 1 | R: —CH₂C≡CH | 1.00 | 79 |
| Ex. 4-5 | | | [EC/EMC/DMC = 3/3/4] + | | | | |
| | | | 1 wt % LiBOB | | | | |
| Ref. | NCM811 | Graphite + SiO | 1M LiPF₆ | 1 | R: —CH₂C≡CH | 0.93 | 46 |
| Ex. 4-6 | | | [EC/EMC/DMC = 3/3/4] + | | | | |
| | | | 1 wt % LiBOB | | | | |

As can be seen from Table 4, when graphite and SiO were used for the negative electrode, the smaller the proportion of LiPF₆ as compared to the proportion of LiFSI, the better the cycling performances (Example 4-1 and Reference Examples 4-1 to 4-4). When only graphite was used for the negative electrode, the cycling performances were improved by adding 1 wt % of LiBOB to the electrolyte containing LiPF₆ (Reference Example 4-5). In contrast, when the electrolyte containing LiBOB was used in the battery in which graphite and SiO were used for the negative electrode, the cycling performances could not be better than the cycling performances obtained in Reference Example 4-4 (Reference Example 4-6). These results demonstrate that, when a five-membered cyclic phosphonic acid ester compound (I) is used in a battery in which graphite containing SiO is used for the negative electrode, the necessity of adding LiBOB is eliminated by mainly using LiFSI as a Li salt and reducing the amount of LiPF₆ as much as possible.

### INDUSTRIAL APPLICABILITY

By using the non-aqueous electrolyte of this disclosure, it becomes possible to provide a battery that is superior in battery characteristics such as a cycle life as well as in safety such as corrosion resistance. Our solution can make an immeasurable contribution to the field in which many LIBs are used for a long period of time, such as the field of automotive batteries.

1. A non-aqueous electrolyte for use in a lithium ion secondary battery that includes a positive electrode, a negative electrode, a separator, and a non-aqueous electrolyte containing a non-aqueous solvent and an electrolyte salt dissolved in the non-aqueous solvent, the non-aqueous electrolyte comprising:
a five-membered cyclic phosphonic acid ester compound (I) represented by the following formula (I) in an amount ranging from 0.01 wt % to 10 wt %: 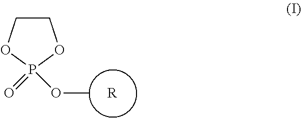
where R represents a —CH₂C≡CH group, a —CH(CH₃)C≡N group, a —C(CH₃)₂C≡N group, or a —CH₂CH₂C≡N group.

2. The non-aqueous electrolyte for use in a lithium ion secondary battery according to claim 1, wherein
R in the five-membered cyclic phosphonic acid ester compound represented by the formula (I) is the —CH₂C≡CH group, and the electrolyte salt does not contain LiPF₆ or LiBOB (C₂O₄)₂.

3. The non-aqueous electrolyte for use in a lithium ion secondary battery according to claim 1, further comprises
1,3-dioxane in an amount ranging from 0.01 wt % to 5 wt %.

4. The non-aqueous electrolyte for use in a lithium ion secondary battery according to claim 1, further comprises
at least one SO₃ group-containing compound selected from the group consisting of 1,3-propanesultone, propargyl methanesulfonate, and 2-cyanoethyl methanesulfonate is contained in an amount ranging from 0.01 wt % to 5 wt %.

5. A lithium ion secondary battery comprising:
a positive electrode;
a negative electrode;
a separator; and
a non-aqueous electrolyte containing a non-aqueous solvent and an electrolyte salt dissolved in the non-aqueous solvent,
wherein the non-aqueous electrolyte comprises:
a five-membered cyclic phosphonic acid ester compound (I) represented by the following formula (I) in an amount ranging from 0.01 wt % to 10 wt %: 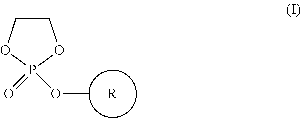
where R represents a —CH₂C≡CH group, a —CH(CH₃)C≡N group, a —C(CH₃)₂C≡N group, or a —CH₂CH₂C≡N group.

6. The lithium ion secondary battery according to claim 5, wherein
the negative electrode contains a silicon-based oxide.

7. The lithium ion secondary battery of claim 5, wherein
R in the five-membered cyclic phosphonic acid ester compound represented by the formula (I) is the —CH₂C≡CH group, and the electrolyte salt does not contain LiPF₆ or LiBOB (C₂O₄)₂.

8. The lithium ion secondary battery according to claim 5, wherein the non-aqueous electrolyte further comprises 1,3-dioxane in an amount ranging from 0.01 wt % to 5 wt %.

9. The lithium ion secondary battery according to claim 5, wherein the non-aqueous electrolyte further comprises at least one SO₃ group-containing compound selected from the group consisting of 1,3-propanesultone, propargyl methanesulfonate, and 2-cyanoethyl methanesulfonate in an amount ranging from 0.01 wt % to 5 wt %.
